(19) United States
(12) Patent Application Publication
(10) Pub. No.: US 2006/0044214 A1
(43) Pub. Date: Mar. 2, 2006

(54) Touch panel video display system for vehicles

(75) Inventor: Suk Ki Hong, Santa Fe Springs, CA (US)

Correspondence Address: JENKENS & GILCHRIST, P.C., 901 15TH STREET N.W., SUITE 900, WASHINGTON, DC, 20005, US

(73) Assignee: NESA International Incorporated

(21) Appl. No.: 10/924,842

(22) Filed: Aug. 25, 2004

(51) Int. Cl. G09G 5/00

(52) U.S. Cl. 345/1.1

(57) ABSTRACT

A touch panel video display system includes: a touch panel video display screen positioned in a rear surface of the portion of the seat such that a passenger behind the seat can view the touch panel video display screen; and an audio video junction controller connected to the touch panel video display screen for connecting one of a plurality of audio video devices to the video display screen in response to a device control input from the touch panel video display screen and for controlling audio from the plurality of audio video devices in response to an audio control input from the touch panel video display screen, wherein one of the plurality of audio video devices is a media player connected to the audio video junction controller such that playback operations of the media player are controlled by an operation input from the touch panel video display screen.

### BACKGROUND OF THE INVENTION

1. Field of the Invention

The present invention relates to a touch panel video display, and more particularly, to a touch panel video display system for vehicles.

2. Discussion of the Related Art

In general, video displays are used in vehicles to display movies from media players, which playback movies from a media format, such as DVD or video cassette. The controls for the playback operations are usually positioned on the media player or sometimes a wireless remote is provided that can be used to control playback operations of the media player. In addition, visual displays can be hooked up to gaming devices so that passengers can play a game. Although there are video display systems that can provide driving information to the driver, such as rearview camera systems, most video displays are mounted in vehicles for viewing by passengers.

A touch panel video display screen is a device in which a touch panel screen overlies a video display. In contrast to where a video display is usually mounted, a touch panel video display screen for vehicles is usually mounted adjacent to the control panel of a vehicle for use by the driver of the vehicle. Such systems can be used for audio visual navigation systems. However, most touch panel video display systems are typically only used for controlling audio devices.

### SUMMARY OF THE INVENTION

Accordingly, the present invention is directed to a touch panel video display system for vehicles that substantially obviates one or more of the problems due to limitations and disadvantages of the related art.

An object of the present invention is to provide a touch panel video display system in a vehicle that can be controlled by a passenger in a vehicle.

Another object of the present invention is to provide a touch panel video display system in a vehicle having a plurality of input devices that can be independently controlled by passengers in a vehicle such that a passenger can view an image from an input device while another passenger is viewing another image from another input device.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the a touch panel display system includes: a touch panel video display screen positioned in a rear surface of the portion of the seat such that a passenger behind the seat can view the touch panel video display screen; and an audio video junction controller connected to the touch panel video display screen for connecting one of a plurality of audio video devices to the video display screen in response to a device control input from the touch panel video display screen and for controlling audio from the plurality of audio video devices in response to an audio control input from the touch panel video display screen, wherein one of the plurality of audio video devices is a media player connected to the audio video junction controller such that playback operations of the media player are controlled by an operation input from the touch panel video display screen.

In another aspect, the a touch panel video display system includes: a first portion of a first seat; a first touch panel video display screen positioned in a rear surface of the first seat such that a first passenger behind the first seat can view the first touch panel video display screen; a second portion of a second seat; a second touch panel video display screen positioned in a rear surface of the second seat such that a second passenger behind the second seat can view the second touch panel video display screen; and an audio video junction controller connected to the first and second touch panel video display screen for respectively connecting two of a plurality of audio video devices to the first and second video display screens in response to device control inputs from the first and second touch panel video display screens.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 illustrates a touch panel video display headrest component.

FIG. 2 illustrates an implementation of the touch panel video screen headrest component shown in FIG. 1.

FIG. 3 illustrates a touch panel video display seatback component.

FIG. 4 is diagram of a touch panel video display system using the touch panel video screen headrest component shown in FIG. 1.

FIGS. 5a and 5b are examples of images on a touch panel video display used to control the touch panel video display system.

### DETAILED DESCRIPTION OF THE PREFERRED EMBODIMENTS

Reference will now be made in detail to the preferred embodiments of the present invention, examples of which are illustrated in the accompanying drawings.

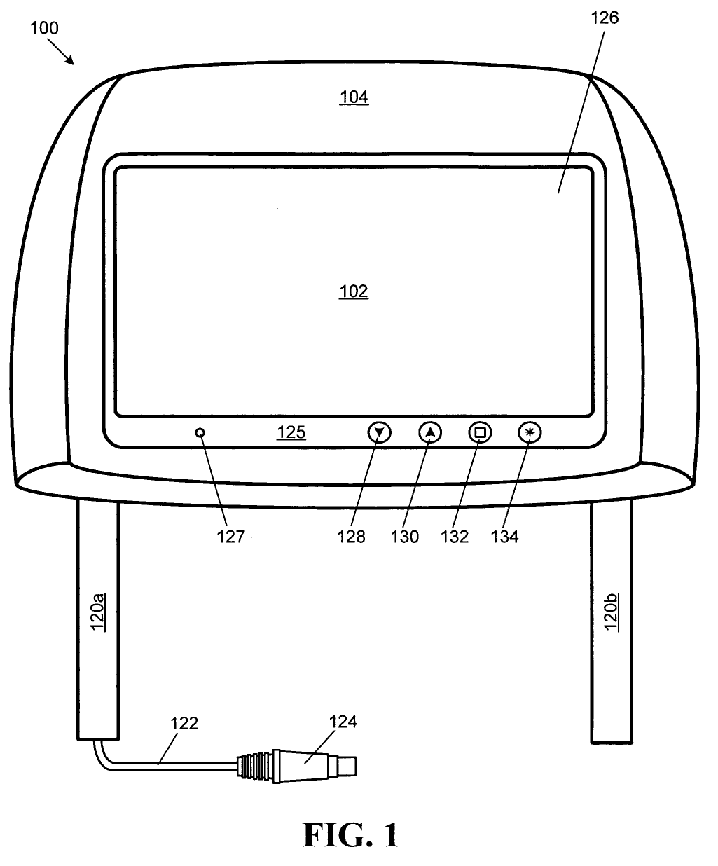

FIG. 1 illustrates a touch panel video display headrest component. As shown in FIG. 1, a touch panel video display headrest component 100 includes a touch panel video display screen 102 in the rear surface of a headrest 104. The touch panel video display headrest component 100 can also include headrest support bars 120a and 120b for mounting the headrest 104 on a seat.

A wire 122, which terminates with a connector 124, is used for electrical connection to the touch panel video display screen 102. The wire 122 can protrude from one of the support bars 120a, as shown in FIG. 1. In the alternative, the wire 122 can be routed through another portion of the headrest 104, such as the bottom side of the headrest adjacent to the top of the seat.

The touch panel video display screen 102 includes a frame 125 that surrounds the display area 126 of the touch panel video display screen 102. An adapter 127 for a listening device is positioned in the frame 125. The adapter 127 can be, for example, a stereo phono jack for a headset. In addition or in the alternative, the frame 125 can have volume controls 128 and 130 as well as a power control 134 for the touch panel video display component 100 or the entire touch panel video display system. In yet another addition or alternative, the frame can have a menu control 132 for selecting devices. Any one or all of these controls can be redundant to controls provided on the touch panel video display screen 102. For example, touching the touch panel video display screen 102 while the touch panel video display component 100 is off could turn on the touch panel video display component 100 just like the power control 134.

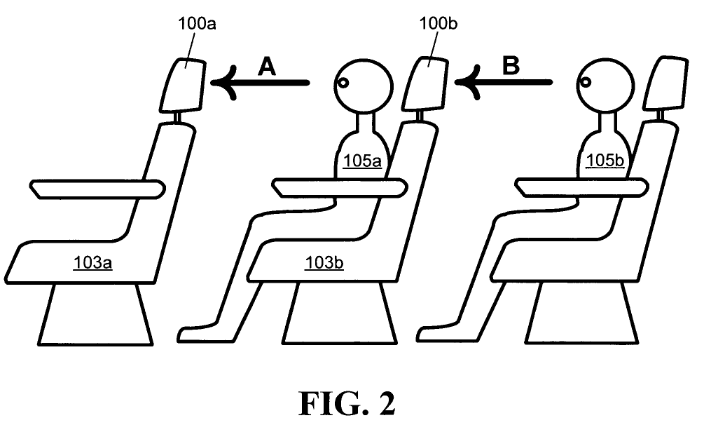

FIG. 2 illustrates an implementation of the touch panel video display headrest component shown in FIG. 1. A touch panel video display screen is mounted in the rear surface of the touch panel video display headrest component 100a of the seat 103a in FIG. 2. Accordingly, a passenger 105a in seat 103b, which is behind the seat 103a can see, as shown by the arrow A, the touch panel video display screen in the touch panel video headrest component 100a. An other touch panel video display screen can be mounted in the rear of the touch panel video display headrest component 100b of the seat 103b in FIG. 2. such that another passenger 105b behind the seat 103b can see, as shown by the arrow B, the other touch panel video display screen.

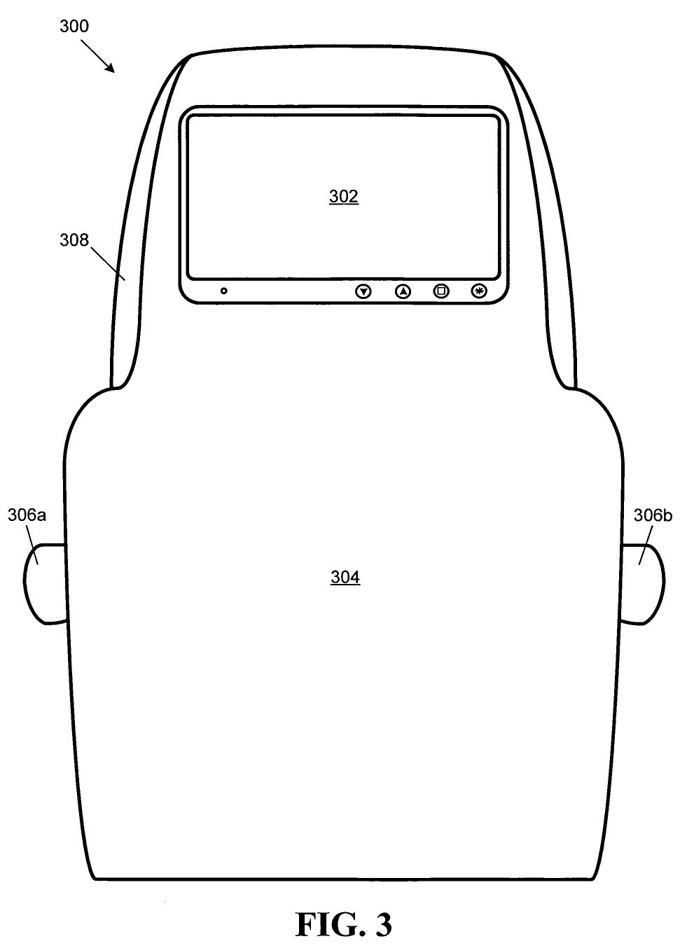

FIG. 3 illustrates a touch panel video display seatback component. As shown in FIG. 3, the touch panel video display seatback component 300 includes a touch panel video display screen 302 in the rear surface of a backrest 304 for a seat. The touch panel video display seatback component 300 can also include armrests 306a and 306b. In addition or in the alternative, the touch panel video display seatback component 300 can also include the cushioning front surface 308 of the backrest for a seat.

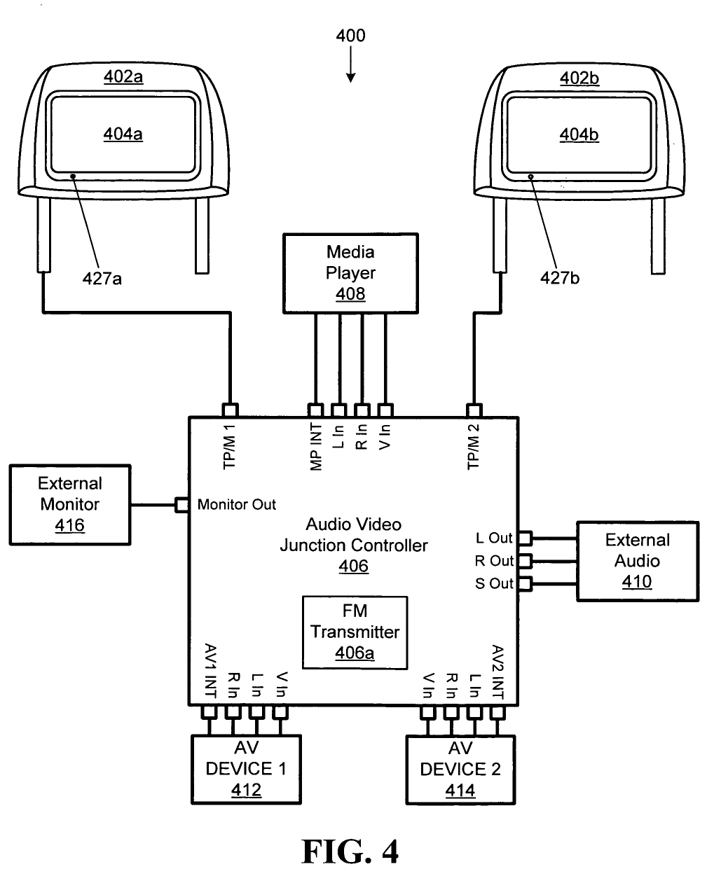

FIG. 4 is diagram of a touch panel video display system using the touch panel video display headrest component shown in FIG. 1. As shown in FIG. 4, the touch panel video display system 400 includes a first touch panel video display headrest component 402a having a first touch panel video display screen 404a and a second touch panel video display headrest component 402b having a second touch panel video display screen 404b that are connected to an audio video junction controller 406. A media player 408 is connected to the audio video junction controller 406. In addition or in the alternative, two other audio video devices 412 and 414 can be connected to the audio video junction controller 406. Although the audio video junction controller 406 has an FM transmitter 406a for wirelessly transmitting audio signals, external two-channel audio (or three-channel audio with subwoofer) 410 can be connected to the external audio outputs of the audio video junction controller 406. Further, an external monitor 416 can be connected to the audio video junction controller 406.

The media player 408 can be, for example, a DVD player or MPEG hardrive player. The playback operations of the media player can be controlled by an operation input from either one of the first and second touch pad video display screens 404a and 404b through the audio video junction controller 406 via interface MP INT with the media player 408. Likewise, the playback operations of the other two audio video devices 412 and 414 can be controlled by either one of first and second touch pad video display screens 404a and 404b through the audio video junction controller 406 via respective interfaces AV1 INT and AV2 INT. However, the other two audio video devices 412 and 414 can be devices in which playback operations are not controlled by an operation input from the first and second touch pad video display screens 404a and 404b.

In any event, one of touch panel video display screens 404a and 404b can be used to connect one of a plurality of audio video devices 412 and 414, including the media player 408, to the one video display screen in response to a device control input from the one touch panel video display screen. Further, the audio for the audio video device connected to a respective touch panel video display screen can be controlled by an audio control input from a respective touch panel video display screen or the volume controls on the frame of the respective touch panel video display screen. Thus, audio for any one of the plurality of devices 408, 412 and 414 can be controlled in response to an audio control input from any one of the touch panel video display screens 404a and 404b.

The audio video junction controller 406, which is connected to the first and second touch panel video display screens 404a and 404b, can simultaneously connect two of the plurality of audio video devices 408, 412 and 414 to the first and second video display screens in response to device control inputs from the first and second touch panel video display screens 404a and 404b. For example, the first touch panel video display screen 404a can be connected to the media player 408 and the second touch panel video display screen 404b can be connected to the audio video device 412. Although the audio video junction controller 406 can control both the audio signal and video signal via audio control input and device control input from the touch panel video display screens, playback operation of an audio video device can only be controlled if an interface exist between the audio video junction controller 406 and the audio video devices 408, 412 and 414.

FIG. 4 shows an interface between the audio video junction controller 406 and each of the audio video devices 408, 412 and 414. As mentioned above, the two audio video devices 412 and 414 can be devices in which playback operations are not controlled by an operation input from the first and second touch pad video display screens 404a and 404b. For example, audio video device 412 may be a video game that only provides audio and video inputs to the audio video junction controller 406. In another example, audio video device 412 may be a video cassette player that only provides audio and video inputs to the audio video junction controller 406.

The first touch panel video display screen 404a can include a first adapter 427a for attaching a listening device such that an audio output signal corresponding to a first video signal from a first audio video device, which is being provided to the first touch panel video display screen, can be heard. The second touch panel video display screen 404b can include a second adapter 427b for attaching a listening device such that an audio output signal corresponding to a second video signal from a second audio video device, which is provided to the first touch panel video display screen 404b, can be heard. Further, the audio video junction controller 406 can provide a first wireless left audio output signal and a first wireless right audio output signal corresponding to a first video signal from a first audio video device connected to the first touch panel video display screen 404a, and a second wireless left audio output signal and a second wireless right audio output signal corresponding to a second video signal from a second audio video device connected to the second touch panel video display screen 404b from the FM transmitter 406a.

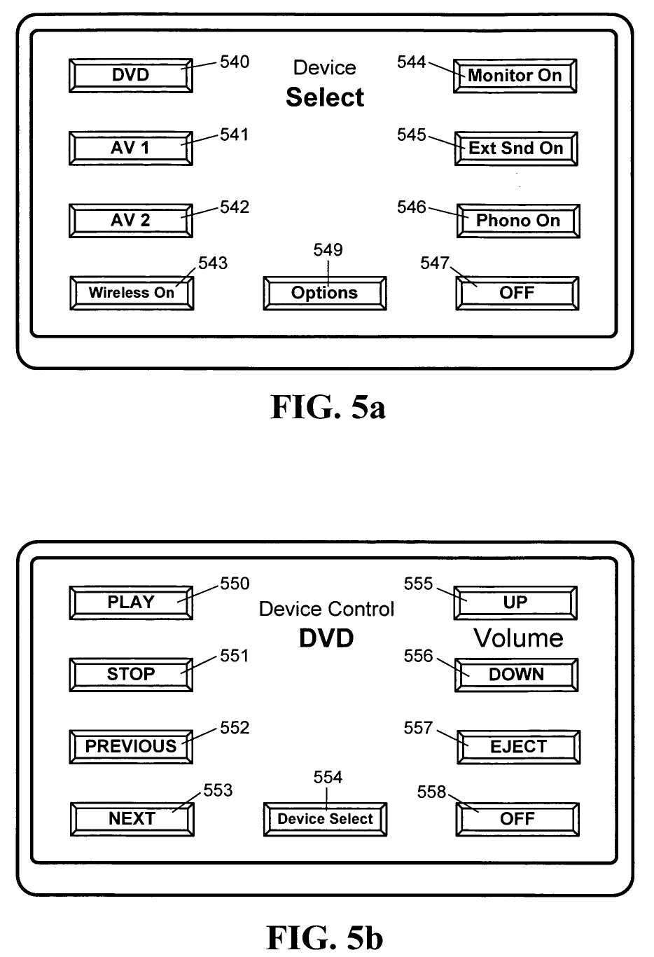

FIGS. 5a and 5b are examples of images on a touch panel video display used to control the touch panel video display system. In particular, FIG. 5a is an illustration of a Device Select screen in which audio video devices can be selected or other features of the touch panel video display system can be controlled. FIG. 5a shows device buttons, such as a DVD button 540, an AV 1 button 541 and AV 2 button 542, that send a device control input to the audio video junction controller when such buttons are activated. In response to device control input, the audio video junction controller connects the device corresponding to the device control input to the touch panel video display screen.

FIG. 5a also shows that the Device Select screen includes a Wireless On button 543, a Monitor On button 544 and an Ext Snd On button 545, for controlling outputs from the audio video junction controller. In addition, the Device Select screen shown in FIG. 5a includes a Phono On button 546 for turning on the adapter for a listening device in the frame of the touch panel video display screen. Further, a Device Select screen can include an Off button 547 for turning off the touch panel video display system as well as an Options button 549 for displaying other controls for other touch panel video display system features.

When the Wireless On button 543 is activated by the touch of a passenger, a wireless ON input is sent to the audio video junction controller such that the audio video junction controller provides a wireless left audio output signal and a wireless a right audio output signal corresponding to an audio video signal provided to the touch panel video display screen. Thus, if the Wireless On button 543 is activated on a first touch panel video display screen, the audio video junction controller provides a first wireless left audio output signal and a first wireless right audio output signal corresponding to a first video signal from a first audio video device connected to the first touch panel video display screen. Further, if the Wireless On button 543 is activated on a second touch panel video display screen, the audio video junction controller provides a second wireless left audio output signal and a second wireless right audio output signal corresponding to a second video signal from a second audio video device connected to the second touch panel video display screen.

When the Monitor On button 544 is activated by the touch of a passenger, a monitor ON input is sent to the audio video junction controller so that the audio video junction controller provides a video signal to the monitor corresponding to the video signal for a touch panel video display screen that last sent a monitor ON input to the audio video junction controller. In another words, a monitor ON input from another touch panel video display screen can override a previous monitor ON input from the touch panel video display screen. A monitor OFF input from any touch panel video display screen will turn off the monitor.

When the Ext Snd On button 545 is activated by the touch of a passenger, an external sound ON input is sent to the audio video junction controller so that the audio video junction controller provides a left external audio output, a right external audio output and subwoofer external audio output corresponding to the audio signal of the audio video device selected for that touch panel video display screen. All of the external audio outputs correspond to an audio video signal from the audio video device selected for a touch panel video display screen that last provided an external sound ON input. In contrast, all of the external audio inputs are turned off if an external sound Off input is received from the touch panel video display screen that last provided an external sound ON input or if no external sound inputs have been sent by a touch panel video display screen.

FIG. 5b is an illustration of a Device Control screen for controlling a selected audio video device. The Device Control screen shown in FIG. 5b includes buttons for audio control inputs, such as an UP button 555 and an DOWN button 556, for volume control for an audio video signal from the audio video device selected for a touch panel video display screen. The Device Control screen shown in FIG. 5b also includes buttons for operation inputs, such as a PLAY button 550, a STOP button 551, a PREVIOUS button 552, a NEXT button 553 and an EJECT button 557 for playback operation control of the device selected to be connected to the touch panel video display screen. Further, the Device Control screen shown in FIG. 5b includes an Off button 558 for turning off the touch panel video display system and a SELECT button 554 for accessing a device select screen like shown in FIG. 5a.

It will be apparent to those skilled in the art that various modifications and variations can be made in the touch panel video display system of the present invention without departing from the spirit or scope of the invention. Thus, it is intended that the present invention cover the modifications and variations of this invention provided they come within the scope of the appended claims and their equivalents.

What is claimed is:

1. A touch panel video display system, comprising:
a portion of a seat;
a touch panel video display screen positioned in a rear surface of the portion of the seat such that a passenger behind the seat can view the touch panel video display screen; and
an audio video junction controller connected to the touch panel video display screen for connecting one of a plurality of audio video devices to the video display screen in response to a device control input from the touch panel video display screen and for controlling audio from the plurality of audio video devices in response to an audio control input from the touch panel video display screen,
wherein one of the plurality of audio video devices is a media player connected to the audio video junction controller such that playback operations of the media player are controlled by an operation input from the touch panel video display screen.

2. The touch panel video display system of claim 1, wherein the portion of the seat is a headrest.

3. The touch panel video display system of claim 1, wherein the touch panel video display screen is surrounded by a frame including volume controls.

4. The touch panel video display system of claim 1, wherein the touch panel video display screen is surrounded by a frame including a power control for the system.

5. The touch panel video display system of claim 1, wherein the touch panel video display screen is surrounded by a frame including an adapter for attaching a listening device.

6. The touch panel video display system of claim 1, wherein the audio video junction controller includes a monitor output controlled by a monitor input from the touch panel video display screen so that a video signal provided to the touch panel video display screen is also provided to the monitor.

7. The touch panel video display system of claim 1, wherein the audio video junction controller provides a left external audio output, a right external audio output and subwoofer external audio output that are controlled by an external sound ON input from the touch panel video display screen.

8. The touch panel video display system of claim 1, wherein the audio video junction controller provides a wireless left audio output signal and a wireless a right audio output signal corresponding to an audio video signal provided to the touch video panel display screen.

9. The touch panel video display system of claim 1, further comprising:
an other portion of an other seat; and
another touch panel video display screen positioned in a rear surface of the other seat such that an other passenger behind the other seat can view the other touch panel video display screen,
wherein the audio video junction controller is connected to the other touch panel video display and controls an other audio video device of the plurality of audio video devices in response to a device control input from the other touch panel video display screen and controls audio from the other audio video device of the plurality of devices in response to an audio control input from the other touch panel video display screen.

10. The touch panel video display system of claim 9, wherein the audio video junction controller includes a monitor output controlled by monitor inputs from the touch panel video display screens such that a video signal for a touch panel video display screen having a last monitor input is also provided to the monitor.

11. A touch panel video display system, comprising:
a first portion of a first seat;
a first touch panel video display screen positioned in a rear surface of the first seat such that a first passenger behind the first seat can view the first touch panel video display screen;
a second portion of a second seat;
a second touch panel video display screen positioned in a rear surface of the second seat such that a second passenger behind the second seat can view the second touch panel video display screen; and
an audio video junction controller connected to the first and second touch panel video display screens for respectively connecting two of a plurality of audio video devices to the first and second video display screens in response to device control inputs from the first and second touch panel video display screens.

12. The touch panel video display system of claim 11, wherein at least one of the first and second portions is a headrest.

13. The touch panel video display system of claim 11, wherein the first touch panel video display screen is surrounded by a first frame including volume controls.

14. The touch panel video display system of claim 11, wherein the first touch panel video display screen is surrounded by a first frame including a power control for the system.

15. The touch panel display system of claim 11, wherein the audio video junction controller provides a first wireless left audio output signal and a first wireless right audio output signal corresponding to a first video signal from a first audio video device for the first touch panel video display screen, and a second wireless left audio output signal and a second wireless right audio output signal corresponding to a second video signal from a second audio video device for the second touch panel video display screen.

16. The touch panel display system of claim 11, wherein one of the audio video devices is a media player connected to the audio video junction controller such that playback operations of the media player are controlled by an operation input from either the first touch panel video display screen or second touch panel video display screen.

17. The touch panel video display system of claim 11, wherein the first touch panel video display screen includes a first adapter for attaching a listening device such that an audio output signal corresponding to a first video signal from a first audio video device provided to the first touch panel video display screen can be heard and the second touch panel video display screen includes a second adapter for attaching a listening device such that an audio output signal corresponding to a second video signal from a second audio video device provided to the first touch panel video display screen can be heard.

18. The touch panel video display system of claim 11, wherein the audio video junction controller provides a left external audio output, a right external audio output and subwoofer external audio output that are controlled by an external sound input from the first and second touch panel video display screens.

19. The touch panel video display system of claim 11, wherein one of the video device is a media player connected to the audio video junction controller such that playback operations of the media player are controlled by an operation inputs from the first and second touch panel video display screens.

20. The touch panel video display system of claims 11, wherein the audio video junction controller connected to the first and second touch panel video display screens for controlling audio from the plurality of devices in response to an audio control input from the first and second touch panel video display screens.
